(19) United States
(12) Patent Application Publication
(10) Pub. No.: US 2004/0064865 A1
(43) Pub. Date: Apr. 8, 2004

(54) Cut resistant fabric and glove

(75) Inventor: Joseph Hummel, Perkasie, PA (US)

Correspondence Address: WATTS, HOFFMANN, FISHER & HEINKE CO., L.P.A., P.O. Box 99839, Cleveland, OH, 44199-0830, US

(73) Assignee: Wells Lamont Industry Group, Inc.

(21) Appl. No.: 10/444,030

(22) Filed: May 22, 2003

Related U.S. Application Data
(60) Provisional application No. 60/416,315, filed on Oct. 4, 2002.

(51) Int. Cl. B32B 27/04; B32B 27/12

(52) U.S. Cl. 2/2.5; 442/134

(57) ABSTRACT

A cut-resistant fabric for use in protective apparel that provides cut resistance with relative comfort and low cost. The fabric is knitted from a first end of composite yarn and second and third ends of spun fiber machine-knitted together three-ends-in. The first, second, and third ends are randomly placed within the cut-resistant fabric. The first end is a cut-resistant composite yarn having a cut resistant core wrapped in a plurality of strands of cut resistant material and the second and third ends is a spun fiber. A colored thread is disposed within the cut resistant composite yarn along the cut resistant core to provide a visible indication of wear on the strands of cut resistant material.

### TECHNICAL FIELD

The present invention relates to cut resistant yarn suitable for machine knitting and more particularly a protective apparel that is made with the yarn.

### BACKGROUND OF THE INVENTION

Many jobs that involve the handling of materials require the use of protective gloves to prevent injury. The characteristics of protective gloves such as cost, comfort, and cut resistance vary greatly. Simple cotton gloves are low cost and very comfortable to wear, providing sufficient cut resistance for a large proportion of manual jobs that do not involve exposure to knives or sharp metal edges. At the other end of the protective glove spectrum are cut resistant gloves that are knit from composite cut resistant yarns, known as “cut yarns”, that include cut resistant components such as Kevlar, stainless steel, or other cut resistant fibers wrapped around a core that may or may not be itself cut resistant.

U.S. Pat. No. 6,016,648 to Bettcher et al describes a cut yarn that is suitable for machine knitting. The yarn is made from metal wire or wires wrapped around a core of fiber. Gloves knit from cut yarn such as that described in the Bettcher patent provide excellent cut resistance, but due to their high cost and the relative discomfort to the wearer they are generally only used in industries that involve direct contact with knives or sheet metal. One alternative to cotton gloves that provides an additional measure of cut resistance while maintaining relative low cost and reasonable comfort is a glove made from spun Kevlar yarn. These gloves are widely used in the automotive assembly industry, but tend to wear quickly due to the nature of the spun material. One drawback to gloves made from 100% spun fiber is that it is difficult to tell if the fibers in the glove are worn to a degree such that the cut resistance is reduced. Often, two pairs of gloves are worn to add a margin of safety when the amount of wear on a single pair of gloves is uncertain.

### SUMMARY OF THE INVENTION

By knitting one end of composite cut resistant yarn with two ends of spun fiber, a durable, low cost cut resistant fabric can be provided for use in protective apparel that is relatively light weight and comfortable. A cut-resistant fabric is machine-knitted from a first end of composite yarn and second and third ends of spun fiber. The ends are knitted together three-ends-in, resulting in a random placement of the first, second, and third ends within the cut-resistant fabric. The first end is a cut-resistant composite yarn having a cut resistant core wrapped in a plurality of strands of cut resistant material and the second and third of said ends are a spun fiber.

In one embodiment, the cut resistant core is comprised of 400 denier kevlar with 1 filament of 0.002 stainless steel and the strands are identical and are comprised of polyester. The spun fibers can be of for example, cotton or Kevlar. In a exemplary embodiment, the first, second, and third ends are randomly distributed throughout the fabric such that the first end is on the top surface of the fabric about 50% of the time. In another exemplary embodiment, the first, second, and third ends are randomly distributed throughout the fabric such that the first end is on the top surface of the fabric about 30% of the time. In a preferred embodiment, a colored thread is disposed within the cut resistant composite yarn along the cut resistant core to provide a visible indication of wear on the strands of cut resistant material.

Additional features of the invention will become apparent and a fuller understanding obtained by reading the following detailed description made in connection with the accompanying drawings.

### BRIEF DESCRIPTION OF THE DRAWINGS

FIG. 1 shows a cut resistant glove made from fabric constructed according to an embodiment of the present invention;

FIG. 2 shows a cut resistant yarn that is used to make cut resistant fabric according to an embodiment of the present invention; and

FIG. 3 shows cut resistant fabric constructed according to an embodiment of the present invention.

### DETAILED DESCRIPTION OF THE PREFERRED EMBODIMENT

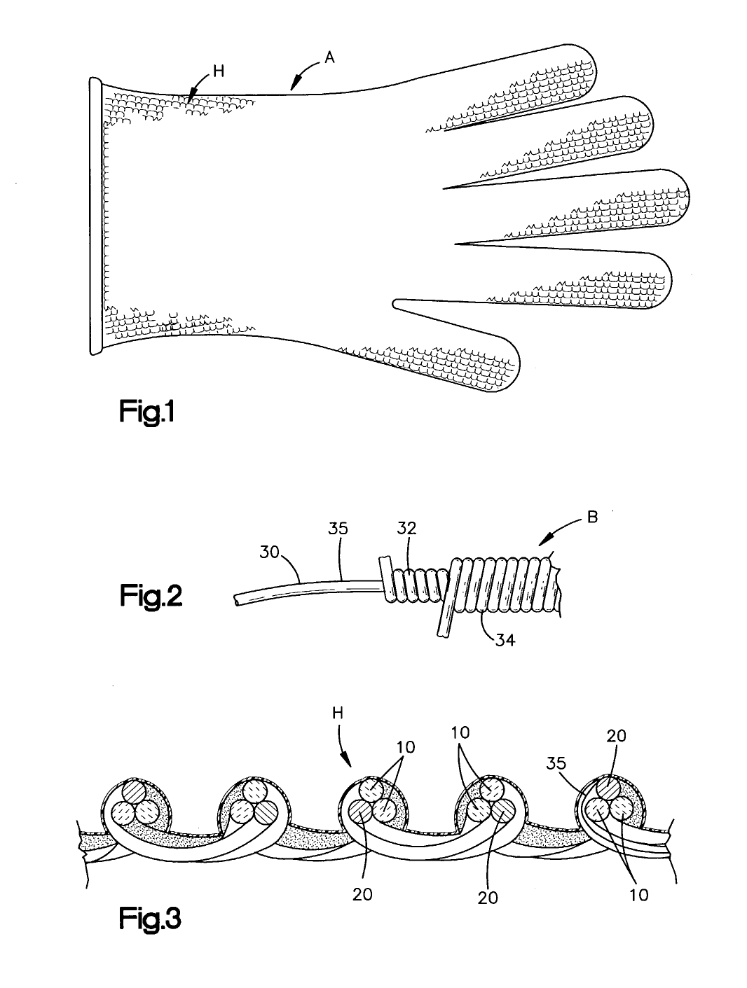

FIG. 1 illustrates a glove A constructed from fabric knitted from composite cut resistant yarn and spun fibers. The surface of the glove has a mottled appearance due to the random distribution of the spun fibers and the cut yarn on the surface of the glove in proportions to be described in more detail below. While FIG. 1 shows a glove constructed entirely from the inventive cut resistant fabric, the glove could also be constructed with a combination of fabrics that includes the fabric described herein.

FIG. 2 illustrates the construction of a composite cut resistant yarn 20 that is suitable for knitting cut resistant fabric. A core 30 of 400 Denier Kevlar with 1 filament of 0.002 stainless steel is wrapped with a first and second wraps of a polyester fiber 32, 34 at a rate of ten wraps per inch. For heavy weight gloves the polyester fibers 32, 34 are 420 Denier Blue Polyester. For medium weight gloves the polyester fibers 32, 34 are 150 Denier Black Texturized Polyester. A contrasting colored thread 35 is disposed within the cut resistant composite yarn 20 along the cut resistant core 30 to provide a visible indication of wear on the strands of cut resistant material. When a significant amount of the colored thread is visible, the user will know to that the glove should be discarded.

FIG. 3 illustrates cut resistant fabric H that is knit from a combination of the composite yarn 20 and spun fibers 10 such as Kevlar or cotton. The exact composition of the composite yarn as well as the type of spun fiber can be varied based on specific knitting machine parameters as well as to achieve a range of cut resistance, cost, and comfort levels. A heavy weight version of the fabric is knitted using a seven gauge Shima Knitting machine with one end of the cut yarn 20 and two ends of a 100% spun Kevlar fiber 10. The spun Kevlar size ranges from 14/2 to 20/2. The ends are pulled into the knit structure randomly with the cut yarn being to the surface 50% of the time and the Kevlar to the surface 50% of the time.

Still referring to FIG. 3, a medium weight version of the fabric H is knitted on a seven gauge Shima Knitting machine with one end of the cut yarn and two ends of a 100% spun Kevlar having a size ranging from 14/2 to 20/2. The ends are pulled into the knit structure randomly with the cut yarn being to the surface 30% of the time and the Kevlar 70% of the time.

Combining a composite yarn and a spun fiber to create a cut resistant fabric enables the manufacture of a low cost alternative to 100% spun fiber gloves. String or terry gloves made from the cut resistant fabric provide improved wear and cut resistance characteristics while maintaining comfort. It is believed that the gloves described herein have a useful life that is about 40% longer than standard 100% spun fiber gloves. In addition the gloves can be of a lighter weight overall while providing the same cut resistance. The contrasting colored thread gives a visible indication that the composite yarn is wearing and the gloves need to be discarded, thereby decreasing the need for wearing two pairs of gloves.

I claim:

1. A cut-resistant fabric having a top surface and a bottom surface, the fabric comprising a first end of composite yarn and second and third ends of spun fiber machine-knitted together three-ends-in, resulting in a random placement of said first, second, and third ends within the cut-resistant fabric, the first of said ends comprised of a cut-resistant composite yarn having a cut resistant core wrapped in a plurality of strands of cut resistant material and wherein the second and third of said ends is comprised of a spun fiber.

2. The cut resistant fabric of claim 1 wherein the cut resistant core is comprised of 400 denier kevlar with 1 filament of 0.002 stainless steel.

3. The cut resistant fabric of claim 1 wherein the strands are comprised of polyester.

4. The cut resistant fabric of claim 1 comprising two strands of identical cut resistant material.

5. The cut resistant fabric of claim 1 wherein the first, second, and third ends are randomly distributed throughout the fabric such that the first end is on the top surface of the fabric about 50% of the time.

6. The cut resistant fabric of claim 1 wherein the first, second, and third ends are randomly distributed throughout the fabric such that the first end is on the top surface of the fabric about 30% of the time.

7. The cut resistant fabric of claim 1 wherein the second and third ends are spun cotton.

8. The cut resistant fabric of claim 1 wherein the second and third ends are spun Kevlar.

9. The cut resistant fabric of claim 1 wherein a colored thread is disposed within the cut resistant composite yarn along the cut resistant core to provide a visible indication of wear on the strands of cut resistant material.
